(19) United States
(12) Patent Application Publication
(10) Pub. No.: US 2023/0144279 A1
(43) Pub. Date: May 11, 2023

(54) GATE-ON-ARRAY (GOA) CIRCUIT AND DISPLAY DEVICE

(71) Applicant: Shenzhen China Star Optoelectronics Semiconductor Display Technology Co., Ltd., Shenzhen, Guangdong (CN)

(72) Inventor: Longqiang SHI, Shenzhen, Guangdong (CN)

(73) Assignee: Shenzhen China Star Optoelectronics Semiconductor Display Technology Co., Ltd., Shenzhen, Guangdong (CN)

(21) Appl. No.: 16/969,248

(22) PCT Filed: May 8, 2020
(86) PCT No.: PCT/CN2020/089126

§ 371 Date: Aug. 12, 2020

(30) Foreign Application Priority Data
Mar. 31, 2020 (CN) 202010243601.0

(51) Int. Cl. G09G 3/3266

(52) U.S. Cl. CPC G09G 3/3266; G09G 2310/062

(57) ABSTRACT

A gate-on-array (GOA) circuit is provided, and the GOA circuit includes a plurality of rows of cascading GOA units, at least four clock signal lines, and a first start trigger signal line. The plurality of rows of GOA units are divided into odd-row GOA units and even-row GOA units, and a first GOA unit of the odd-row GOA units is connected to the first start trigger signal line.

### TECHNICAL FIELD

The present application relates to a display technology field, in particular to a gate-on-array (GOA) circuit and a display device.

### BACKGROUND

In an active-matrix organic light-emitting diode (AMOLED) display device, since thin-film transistors are subject to electrical stress for extended periods, light-emitting performance of OLEDs will change. Therefore, the AMOLED display device needs to be compensated. One of compensation ways is to add an external compensation circuit to perform an external compensation upon shutdown.

Currently, gate-on-array (GOA) technology is a main technology to realize narrow borders. Under conditions of a large size and a high refresh frequency, waveforms of G(n) output by a GOA circuit are affected, and a gate electrode cannot be driven normally, thereby affecting display. Currently, a solution of using a plurality of clock signals to control the GOA circuit is used to increase charging time in an existing technology, but waveforms of adjacent G(n) signals will overlap. When the external compensation is performed upon shutdown, the waveforms of the G(n) signals are required to not overlap, otherwise correct signals cannot be read. Therefore, it is necessary to improve this defect.

### Technical Problem

The present application provides a gate-on-array (GOA) circuit configured to solve a technical problem of a GOA circuit in the prior art: when the GOA circuit is controlled to drive by a plurality of clock signals, it is incompatible with an external compensation.

### Technical Solution

An embodiment of the present application provides a GOA circuit configured to provide a display panel with a row scan driving signal and a driving signal of a compensation circuit and comprising a plurality of rows of cascading GOA units, at least four clock signal lines, and a first start trigger signal line. Wherein, each of the plurality of rows of GOA units is connected to one of the at least four clock signal lines. The plurality of rows of GOA units are divided into odd-row GOA units and even-row GOA units, and a first GOA unit of the odd-row GOA units is connected to the first start trigger signal line. Wherein, in a compensation stage, when a waveform of a first start trigger signal provided by the first start trigger signal line corresponds to an odd-numbered frame, the odd-row GOA units start to work, and the even-row GOA units are reset; when the waveform of the first start trigger signal corresponds to an even-numbered frame, the even-row GOA units start to work, and the odd-row GOA units are reset.

In the GOA circuit provided by the embodiment of the present application, in the compensation stage, the clock signal lines corresponding to the odd-row GOA units provide pulse signals during the odd-numbered frames, and the clock signal lines corresponding to the even-row GOA units provide low potential signals during the odd-numbered frames; and the clock signal lines corresponding to the odd-row GOA units provide low potential signals during the even-numbered frames, and the clock signal lines corresponding to the even-row GOA units provide pulse signals during the even-numbered frames.

In the GOA circuit provided by the embodiment of the present application, the plurality of rows of GOA units are cascaded by ways of cascading the odd-row GOA units and cascading the even-row GOA units.

In the GOA circuit provided by the embodiment of the present application, the GOA circuit further comprises a second start trigger signal line, wherein a second GOA unit of the even-row GOA units is connected to the second start trigger signal line.

In the GOA circuit provided by the embodiment of the present application, in the compensation stage, a second start trigger signal provided by the second start trigger signal line corresponds to the even-numbered frame, and the first start trigger signal corresponds to the odd-numbered frame.

An embodiment of the present application provides a display device comprising a display panel and a gate-on-array (GOA) circuit, wherein the GOA circuit is disposed on the display panel and configured to provide the display panel with a row scan driving signal and a driving signal of a compensation circuit, and the GOA circuit comprises a plurality of rows of cascading GOA units, at least four clock signal lines, and a first start trigger signal line. Wherein, each of the plurality of rows of GOA units is connected to one of the at least four clock signal lines, respectively. The plurality of rows of GOA units are divided into odd-row GOA units and even-row GOA units, and a first GOA unit of the odd-row GOA units is connected to the first start trigger signal line. Wherein, in a compensation stage, when a waveform of a first start trigger signal provided by the first start trigger signal line corresponds to an odd-numbered frame, the odd-row GOA units start to work, and the even-row GOA units are reset; when the waveform of the first start trigger signal corresponds to an even-numbered frame, the even-row GOA units start to work, and the odd-row GOA units are reset.

In the GOA circuit provided by the embodiment of the present application, in the compensation stage, the clock signal lines corresponding to the odd-row GOA units provide pulse signals during the odd-numbered frames, and the clock signal lines corresponding to the even-row GOA units provide low potential signals during the odd-numbered frames; the clock signal lines corresponding to the odd-row GOA units provide low potential signals during the even-numbered frames, and the clock signal lines corresponding to the even-row GOA units provide pulse signals during the even-numbered frames.

In the GOA circuit provided by the embodiment of the present application, the plurality of rows of GOA units are cascaded by ways of cascading the odd-row GOA units and cascading the even-row GOA units.

In the GOA circuit provided by the embodiment of the present application, the GOA circuit further comprises a second start trigger signal line, wherein a second GOA unit of the even-row GOA units is connected to the second start trigger signal line.

In the GOA circuit provided by the embodiment of the present application, in the compensation stage, a second start trigger signal provided by the second start trigger signal line corresponds to the even-numbered frame, and the first start trigger signal corresponds to the odd-numbered frame.

### Beneficial Effect

According to a gate-on-array (GOA) circuit provided by the present application, in a compensation stage, when a waveform of a first start trigger signal provided by a first start trigger signal line corresponds to an odd-numbered frame, odd-row GOA units are controlled to start to work, and even-row GOA units are reset; when the waveform of the first start trigger signal corresponds to an even-numbered frame, the even-row GOA units are controlled to start to work, and the odd-row GOA units are reset. It may make waveforms of G(n) output by the GOA circuit not overlap, and solve a technical problem that when the GOA circuit is controlled to drive by a plurality of clock signals, it is incompatible with an external compensation.

### DESCRIPTION OF DRAWINGS

FIG. 1 is a schematic diagram showing a driving structure of a gate-on-array (GOA) circuit according to a first embodiment of the present application.

FIG. 2 is a waveform diagram showing a timing sequence of clock signals corresponding to a compensation stage according to the first embodiment of the present application.

FIG. 3 is a waveform diagram showing a timing sequence of driving signals G(n) corresponding to the compensation stage according to the first embodiment of the present application.

FIG. 4 is a schematic diagram showing a driving structure of a GOA circuit according to a second embodiment of the present application.

FIG. 5 is a waveform diagram showing a timing sequence of clock signals corresponding to a compensation stage according to the second embodiment of the present application.

FIG. 6 is a waveform diagram showing a timing sequence of driving signals G(n) corresponding to the compensation stage according to the second embodiment of the present application.

### DETAILED DESCRIPTION OF PREFERRED EMBODIMENTS

To make objectives, technical solutions, and effects of the present application clearer and more specific, the present application is described in further detail below with reference to embodiments in accompanying with appending drawings. It should be understood that the specific embodiments described herein are merely for explaining the present application, and is not used to limit the present application.

An embodiment of the present application provides a gate-on-array (GOA) circuit that is configured to provide a display panel with a row scan driving signal G(n) and a driving signal G(n) of a compensation circuit and includes a plurality of rows of cascading GOA units, at least four clock signal lines, and a first start trigger signal line. A first start trigger signal provided by the first start trigger signal line is used to control the plurality of rows of GOA units to be turned on, and clock signals provided by the at least four clock signal lines are used to control outputs of the plurality of rows of GOA units.

Wherein, each of the plurality of rows of GOA units is connected to one of the at least four clock signal lines. The plurality of rows of GOA units are divided into odd-row GOA units and even-row GOA units, and a first GOA unit of the odd-row GOA units is connected to the first start trigger signal line.

Wherein, in a compensation stage, when a waveform of the first start trigger signal provided by the first start trigger signal line corresponds to an odd-numbered frame, the odd-row GOA units start to work, and the even-row GOA units are reset; when the waveform of the first start trigger signal corresponds to an even-numbered frame, the even-row GOA units start to work, and the odd-row GOA units are reset. This way, it is possible to avoid problems of errors in external compensation reading signals and a poor display caused by the overlapping of waveforms of G(n).

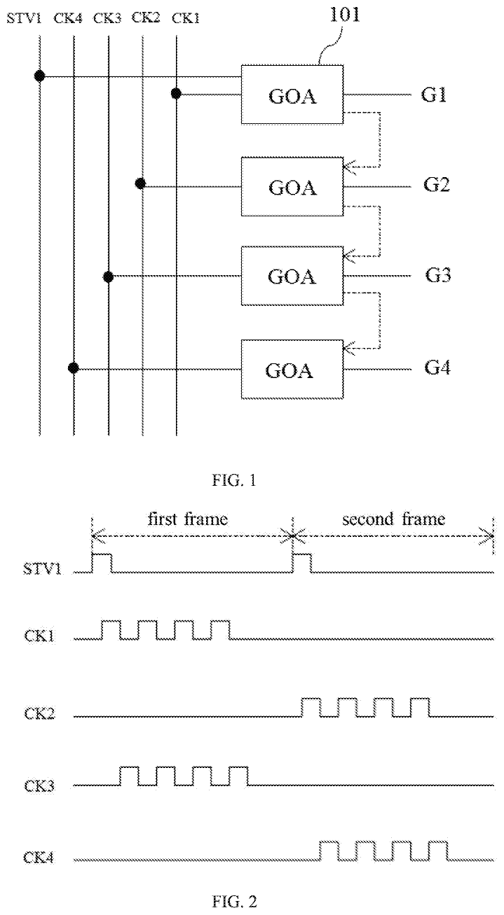

As shown in FIG. 1, which is a schematic diagram showing a driving structure of a GOA circuit according to a first embodiment of the present application. Components of the present circuit and connections between the components can be intuitively seen from the figure. The GOA circuit includes four rows of cascading GOA units, four clock signal lines, and the first start trigger signal line. Wherein, each of the four rows of GOA units is connected to one of the four clock signal line. The four rows of GOA units are divided into odd-row GOA units and even-row GOA units, and a first GOA unit 101 of the odd-row GOA units is connected to the first start trigger signal line.

It should be explained that four rows of GOA units and four clock signal lines are taken as examples in the present embodiment. In other embodiments, there may be more than four rows of GOA units and more than four clock signal lines.

It should be explained that a first start trigger signal STV1 provided by the first start trigger signal line is used to control the first GOA unit 101 of the odd-row GOA units to turn on the odd-row GOA units, and clock signals CK1, CK2, CK3, and CK4 provided by the four clock signal lines are used to control outputs of the four rows of GOA units, respectively.

It should be explained that the four rows of GOA units are cascaded in series. That is, any row of the GOA units is triggered by an output signal of a previous row of the GOA unit, and the first GOA unit 101 is triggered by the first start trigger signal STV1.

In the present embodiment, in a compensation stage, when a waveform of the first start trigger signal STV1 provided by the first start trigger signal line corresponds to an odd-numbered frame, the odd-row GOA units start to work, and the even-row GOA units are reset; when the waveform of the first start trigger signal STV1 corresponds to an even-numbered frame, the even-row GOA units start to work, and the odd-row GOA units are reset.

Specifically, as shown in FIG. 2, which is a waveform diagram showing a timing sequence of clock signals corresponding to the compensation stage according to the first embodiment of the present application. In the compensation stage, the clock signal lines CK1, CK3 corresponding to the odd-row GOA units provide pulse signals during the odd-numbered frames, and the clock signal lines CK2, CK4 corresponding to the even-row GOA units provide low potential signals during the odd-numbered frames; the clock signal lines CK1, CK3 corresponding to the odd-row GOA units provide low potential signals during the even-numbered frames, and the clock signal lines CK2, CK4 corresponding to the even-row GOA units provide pulse signals during the even-numbered frames. It should be explained that two refresh frequencies are taken as an example in the present embodiment, that is, two frames.

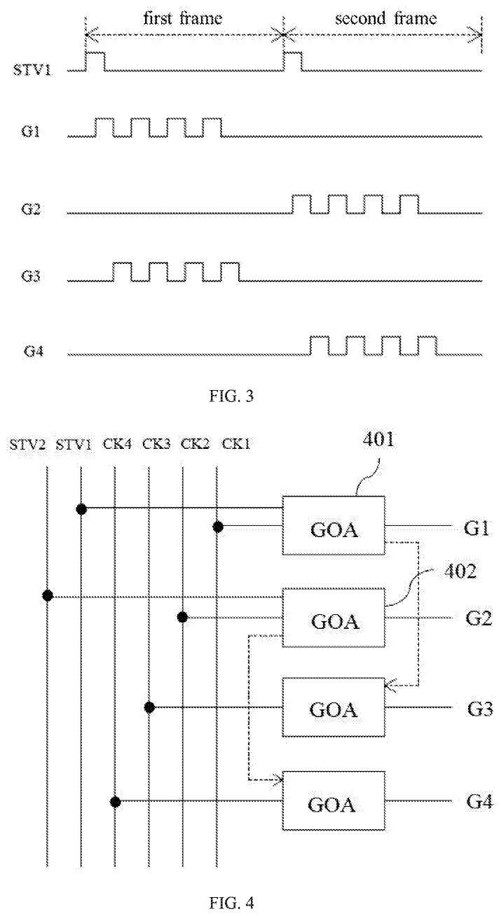

Specifically, as shown in FIG. 3, which is a waveform diagram showing a timing sequence of driving signals G(n) corresponding to the compensation stage according to the first embodiment of the present application. In the compensation stage, driving signals G1, G3 output by the odd-row GOA units are pulse signals during the odd-numbered frames (start working), and driving signals G2, G4 output by the even-row GOA units are low potential signals during the odd-numbered frames (to be reset); the driving signals G1, G3 output by the odd-row GOA units are low potential signals during the even-numbered frames (to be reset), and the driving signals G2, G4 output by the even-row GOA units are pulse signals during the even-numbered frames (start working).

It should be explained that since an order of driving time (in milliseconds) of pixels compensated at shutdown is greater than an order of driving time (in microseconds) of the pixels during normal operation, so that charging speed is faster when the compensation is performed upon shutdown, and charging time is sufficient, and the waveforms of G(n) are not required to overlap each other.

It should be explained that a way for compensating the GOA circuit provided by the first embodiment of the present application is a way of sequentially compensating the odd-row and even-row GOA units, that is, a way of “the odd-row GOA units are compensated during the odd-numbered frames, the even-row GOA units are compensated during the even-numbered frames” is alternately performed in sequence. Since the waveforms of G(n) output by the odd-row and even-row GOA units do not overlap, external compensation may be effectively performed, thereby solving the problem that the plurality of clock signals used to drive are not compatible with the external compensation.

As shown in FIG. 4, which is a schematic diagram showing a driving structure of a GOA circuit according to a second embodiment of the present application. Components of the present circuit and connections between the components can be intuitively seen from the figure. The GOA circuit includes four rows of cascading GOA units, four clock signal lines, the first start trigger signal line, and a second start trigger signal line. Wherein, each of the four rows of GOA units is connected to one of the four clock signal lines. The four rows of GOA units are divided into odd-row GOA units and even-row GOA units, a first GOA unit 401 of the odd-row GOA units is connected to the first start trigger signal line, and a second GOA unit 402 of the odd-row GOA units is connected to the first start trigger signal line.

It should be explained that four rows of GOA units and four clock signal lines are taken as examples in the present embodiment. In other embodiments, they may be more than four rows of GOA units and more than four clock signal lines.

It should be explained that the first start trigger signal STV1 provided by the first start trigger signal line is used to control the first GOA unit 401 of the odd-row GOA units and to turn on the odd-row GOA units, a second start trigger signal STV2 provided by the second start trigger signal line is used to control the second GOA unit 402 of the even-row GOA units and to turn on the even-row GOA units, and the clock signals CK1, CK2, CK3, and CK4 provided by the four clock signal lines are used to control outputs of the four rows of GOA units, respectively.

It should be explained that the four rows of GOA units are cascaded by ways of cascading the odd-row GOA units and cascading the even-row GOA units. That is, any row of the GOA units is triggered by an output signal of the previous row of the GOA unit. The first GOA unit 401 is triggered by the first start trigger signal STV1, and the second GOA unit 402 is triggered by the second start trigger signal STV2.

In the present embodiment, in the compensation stage, when a waveform of the first start trigger signal STV1 provided by the first start trigger signal line corresponds to an odd-numbered frame, the odd-row GOA units start to work and the even-row GOA units are reset, and when the waveform of the first start trigger signal STV1 corresponds to an even-numbered frame, the even-row GOA units start to work and the odd-row GOA units are reset.

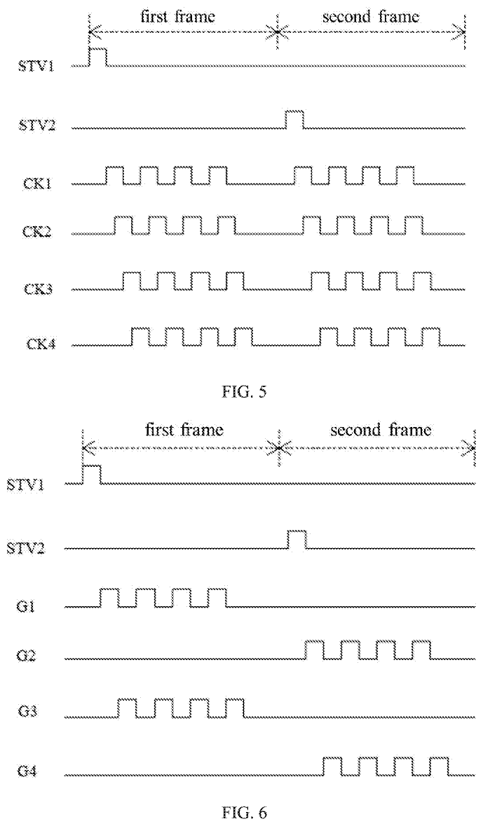

Specifically, as shown in FIG. 5, which is a waveform diagram showing a timing sequence of clock signals corresponding to the compensation stage according to the second embodiment of the present application. In the compensation stage, the waveforms of clock signals are consistent with the waveforms of the clock signal in a normal working stage, and the clock signals are provided with pulse signals. The first start trigger signal STV1 provided by the first start trigger signal line corresponds to the odd-numbered frame, and the second start trigger signal STV2 provided by the second start trigger signal line corresponds to the even-numbered frame.

Specifically, as shown in FIG. 6, which is a waveform diagram showing a timing sequence of driving signals G(n) corresponding to the compensation stage according to the second embodiment of the present application. In the compensation stage, driving signals G1, G3 output by the odd-row GOA units are pulse signals during the odd-numbered frames (start working), driving signals G2, G4 output by the even-row GOA units are low potential signals during the odd-numbered frames (to be reset) the driving signals G1, G3 output by the odd-row GOA units are low potential signals during the even-numbered frames (to be reset), and the driving signals G2, G4 output by the even-row GOA units are pulse signals during the even-numbered frames (start working).

It should be explained that a way for compensating the GOA circuit provided by the second embodiment of the present application is to adopt the two start trigger signals STV1, STV2 to control the odd-row and the even-row GOA units to be turned on, respectively. The first start trigger signal STV1 is connected to the first GOA unit, and the second start trigger signal STV2 is connected to the second GOA unit, so that the odd-row clock signal lines (CK1, CK3) can be controlled by STV1, and the even-row clock signal lines (CK2, CK4) can be controlled by STV2.

It should be explained that when compensating upon shutdown, STV1 is output for turning on during the odd-numbered frames, STV2 is output for turning on during the even-numbered frames, and other signals remain unchanged, so that the odd-row GOA units are turned on during the odd-numbered frames, and the even-row GOA units are turned on during the even-numbered frames. Since the waveforms of G(n) output by the odd-row and even-row GOA units not overlap to each other, external compensation can be performed effectively, thereby solving the problem that the plurality of clock signals used to drive are not compatible with the external compensation

An embodiment of the present application provides a display device including a display panel and a GOA circuit, the GOA circuit is disposed on the display panel and is configured to provide the display panel with a row scan driving signal and a driving signal of a compensation circuit, and the GOA circuit includes a plurality of rows of cascading GOA units, at least four clock signal lines, and a first start trigger signal line. Wherein, each of the plurality of rows of GOA units is connected to one of the at least four clock signal lines, respectively. The plurality of rows of GOA units are divided into odd-row GOA units and even-row GOA units, and the first GOA unit of the odd-row GOA units is connected to the first start trigger signal line. Wherein, in the compensation stage, when the waveform of the first start trigger signal provided by the first start trigger signal line corresponds to an odd-numbered frame, the odd-row GOA units start to work and the even-row GOA units are reset, and when the waveform of the first start trigger signal corresponds to an even-numbered frame, the even-row GOA units start to work and the odd-row GOA units are reset. The operating procedures here are the same as the first embodiment and the second embodiment described above, and will not be repeated here.

The display device provided by the embodiment of the present application may be any product or component having a display function, such as a mobile phone, a tablet computer, a television, a display, a notebook computer, a digital camera, a navigator, and the like.

In summary, according to the GOA circuit provided by the embodiment of the present application, in the compensation stage, when the waveform of the first start trigger signal provided by the first start trigger signal line corresponds to the odd-numbered frame, the odd-row GOA units are controlled to start to work and the even-row GOA units are reset, when the waveform of the first start trigger signal corresponds to the even-numbered frame, the even-row GOA units are controlled to start to work, and the odd-row GOA units are reset. It causes the waveforms of G(n) output by the GOA circuits not overlap each other, and solves a technical problem of a GOA circuit in the prior art that the plurality of clock signals used to drive the GOA circuit are not compatible with the external compensation.

It can be understood that for persons skilled in this art, equivalent replacements or changes may be made according to the technical solutions and inventive concepts of the present application, and these changes or replacements should fall within a protection scope of the claims appended to the present application.

What is claimed is:

1. A gate-on-array (GOA) circuit, configured to provide a display panel with a row scan driving signal and a driving signal of a compensation circuit and comprising a plurality of rows of cascading GOA units, at least four clock signal lines, and a first start trigger signal line;
wherein each of the plurality of rows of GOA units is connected to one of the at least four clock signal lines;
wherein the plurality of rows of GOA units are divided into odd-row GOA units and even-row GOA units, and a first GOA unit of the odd-row GOA units is connected to the first start trigger signal line; and
wherein in a compensation stage, when a waveform of a first start trigger signal provided by the first start trigger signal line corresponds to an odd-numbered frame, the odd-row GOA units start to work, and the even-row GOA units are reset; when the waveform of the first start trigger signal corresponds to an even-numbered frame, the even-row GOA units start to work, and the odd-row GOA units are reset.

2. The GOA circuit as claimed in claim 1, wherein in the compensation stage, the clock signal lines corresponding to the odd-row GOA units provide pulse signals during the odd-numbered frames, and the clock signal lines corresponding to the even-row GOA units provide low potential signals during the odd-numbered frames; and
the clock signal lines corresponding to the odd-row GOA units provide low potential signals during the even-numbered frames, and the clock signal lines corresponding to the even-row GOA units provide pulse signals during the even-numbered frames.

3. The GOA circuit as claimed in claim 1, wherein the plurality of rows of GOA units are cascaded by ways of cascading the odd-row GOA units and cascading the even-row GOA units.

4. The GOA circuit as claimed in claim 3, further comprising a second start trigger signal line, wherein a second GOA unit of the even-row GOA units is connected to the second start trigger signal line.

5. The GOA circuit as claimed in claim 4, wherein in the compensation stage, a second start trigger signal provided by the second start trigger signal line corresponds to the even-numbered frame, and the first start trigger signal corresponds to the odd-numbered frame.

6. A display device, comprising a display panel and a gate-on-array (GOA) circuit, wherein the GOA circuit is disposed on the display panel and configured to provide the display panel with a row scan driving signal and a driving signal of a compensation circuit, and the GOA circuit comprises a plurality of rows of cascading GOA units, at least four clock signal lines, and a first start trigger signal line;
wherein each of the plurality of rows of GOA units is connected to one of the at least four clock signal lines, respectively;
wherein the plurality of rows of GOA units are divided into odd-row GOA units and even-row GOA units, and a first GOA unit of the odd-row GOA units is connected to the first start trigger signal line; and
wherein in a compensation stage, when a waveform of a first start trigger signal provided by the first start trigger signal line corresponds to an odd-numbered frame, the odd-row GOA units start to work, and the even-row GOA units are reset; when the waveform of the first start trigger signal corresponds to an even-numbered frame, the even-row GOA units start to work, and the odd-row GOA units are reset.

7. The display device as claimed in claim 6, wherein in the compensation stage, the clock signal lines corresponding to the odd-row GOA units provide pulse signals during the odd-numbered frames, and the clock signal lines corresponding to the even-row GOA units provide low potential signals during the odd-numbered frames; the clock signal lines corresponding to the odd-row GOA units provide low potential signals during the even-numbered frames, and the clock signal lines corresponding to the even-row GOA units provide pulse signals during the even-numbered frames.

8. The display device as claimed in claim 6, wherein the plurality of rows of GOA units are cascaded by ways of cascading the odd-row GOA units and cascading the even-row GOA units.

9. The display device as claimed in claim 8, further comprising a second start trigger signal line, wherein a second GOA unit of the even-row GOA units is connected to the second start trigger signal line.

10. The display device as claimed in claim 9, wherein in the compensation stage, a second start trigger signal provided by the second start trigger signal line corresponds to the even-numbered frame, and the first start trigger signal corresponds to the odd-numbered frame.
